(19) United States
(12) Patent Application Publication
(10) Pub. No.: US 2008/0194403 A1
(43) Pub. Date: Aug. 14, 2008

(54) Laser Recording Thermally Sensitive Recording Medium

(76) Inventors: Junpei Natsui, Tokyo (JP); Yoshihide Kimura, Tokyo (JP); Kenji Hirai, Tokyo (JP)

Correspondence Address: FLYNN THIEL BOUTELL & TANIS, P.C., 2026 RAMBLING ROAD, KALAMAZOO, MI, 49008-1631, US

(21) Appl. No.: 10/585,895

(22) PCT Filed: Jan. 13, 2005
(86) PCT No.: PCT/JP05/00626

§ 371 Date: Jul. 11, 2006

(30) Foreign Application Priority Data
Jan. 13, 2004 (JP) 2004-005134
Jan. 13, 2004 (JP) 2004-005135

(51) Int. Cl. B41M 5/30

(52) U.S. Cl. 503/201; 503/220

(57) ABSTRACT

A laser recording thermally sensitive recording medium comprising, at least a photo absorbing material which absorbs laser ray and covert the laser ray to heat, colorless or pale colored basic leuco dye and organic color developing agent on a substrate as main components, wherein said photo absorbing material is a compound represented by general formula (1),

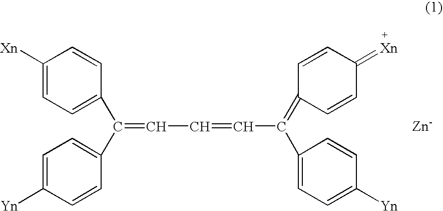

wherein, n indicates an integer of from 1 to 4, and structural formula of Xn, Yn and Zn⁻ are indicated in Table 1.

TABLE 1

| | n = 1 | n = 2 |
|---|---|---|
| Xn | N(C₂H₅)₂ | N(C₂H₅)₂ |
| Yn | N(C₂H₅)₂ | N(C₂H₅)₂ |
| Zn⁻ | 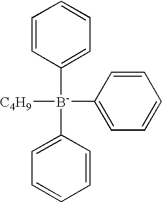 | 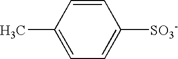 |
| | n = 3 | n = 4 |
| Xn | N(CH₃)₂ | N(C₂H₅)₂ |
| Yn | H | OCH₃ |
| Zn⁻ | CF₃SO₃⁻ | CF₃SO₃⁻ |

### FIELD OF THE INVENTION

The present invention relates to a laser recording thermally sensitive recording medium characterizing that an image can be recorded by irradiation of laser beam.

### BACKGROUND OF THE INVENTION

Among direct recording method which does not need a developing and a fixing process, a thermally sensitive recording paper material which uses electron-donating leuco dye and electron-accepting color developing agent as a color developing agent is widely applied in a facsimile or a printer because of its excellent easy handling and maintenance. However, since this method is characterized to record an image by heat by contacting a thermal head or an exothermic IC pen with a thermally sensitive recording medium directly, fused color forming substance is adhered to the thermal head or the exothermic IC pen, and a trouble such as deposit of dregs or sticking is caused, and there are problem of recording failure or deteriorate the quality of recorded image. In particular, in the case to draw a line continuously along with the flow direction of a record such as plot printer, it is actually impossible to print continuously without causing a problem of deposit of dregs. Further, in the case of recording method using a thermal head, it is said that to improve a resolution to 8 lines/mm or more is difficult.

As a method to dissolve troubles such as deposit of dregs or sticking and to further improve a resolution, a non-contact recording method using laser beam having wavelength close to near-infrared is proposed in Patent Document 1 or Patent Document 2.

However, since said methods are characterized to prepare a light absorbing thermally sensitive color developing layer by adding a near-infrared absorbing agent directly to a coating for a thermally sensitive color developing layer, coating and drying, for the purpose to obtain good color developing ability, it is necessary to increase the adding amount of a near-infrared absorbing agent which absorbs laser beam having wavelength closed to near-infrared and to convert it to heat, and these absorbing agents themselves are slightly colored and deteriorate background color. Further, when adding amount is reduced aiming to lighten the coloring of background color, sufficient color developing density can not be obtained. As a countermeasure, a method to contain a near-infrared absorbing agent in a different layer from a thermally sensitive color developing layer and to accumulate these layers is proposed, however, multi-layers construction is disadvantageous from the view point of production.

Further, in a recent plate making system for news paper, in preparation for PS (Pre-Sensitized) plate which is a plate to print a news paper, plate making process is shifting from conventional printing paper (silver halide film) method to a dry film method which can be recorded by laser, because the conventional method is troublesome in a developing process, has problems of waste liquid and gas, and an operation in a darkroom is necessary. When an error is pointed out at proofreading process, it is necessary to repeat various processes as far as PS, namely, dry film→correction by patch work→reading by a scanner→conversion to electronic information→dry film, in the processes to prepare a PS plate. As a dry film, for example, laser recording thermally sensitive proof disclosed in Patent Document 3 containing a dye which absorbs laser ray and carry out photo-thermal conversion and a color developing material in a thermally sensitive layer can be used.

However, as mentioned above, in a case of conventional recording medium, usually, near-infrared absorbing agents are slightly colored. Therefore, even if a recorded image can be read with naked eyes of human, in a case of optical readout such as a scanner, since contrast of a background color part and an image part is not good, it is difficult to obtain high resolving degree. Accordingly, the conventional recording medium is not actually recognized sufficiently as a dry film which can replace with a printing paper in a plate making system.

In Patent Document 4, following technique is disclosed for the purpose to reduce the background color. That is, a pigment which can convert laser ray to thermal energy and becomes colorless by reacting with a radical and a radical generating agent which generate a radical by irradiating ultra violet ray of 400 nm wavelength or less are contained in a thermally sensitive recording layer and after recorded by laser ray, change the background color to white or colorless by achromatic reaction.

In the meanwhile, opportunities that a thermally sensitive recording medium is used for a good-luck lottery, or a betting ticket for horse racing or motorboat racing are becoming larger. In these uses, since there is a possibility that one thermally sensitive recording paper becomes a one with very high value, it is desired to establish a technique to prevent the forgery which makes impossible to tamper by adding a postscript.

However, in general, a thermally sensitive recording medium is a recording medium which can be added a postscript to non-recorded part after recorded, therefore, it has a problem that other data can be recorded easily. Further, in a case of laser recording thermally sensitive recording medium, high precise letters or image can be recorded, which can not be recorded by a conventional thermal head, there is a peril that tampered point can not be recognized by human's naked eye.

Accordingly, in a photo recording medium containing a pigment which can convert laser ray to thermal energy and a color developing agent, for example, in patent document 5, a technique to make addition of postscript impossible by deactivate the photo/thermo converting ability by decomposing a pigment with irradiation of ray having specific wavelength after image is recorded is disclosed.

Patent Document 1: JPA S58-209594 publication

Patent Document 2: JPA S58-94494 publication

Patent Document 3: JPA 2000-23843 publication

Patent Document 4: JPA H5-278330 publication

Patent Document 5: JPA H7-172054 publication

### DISCLOSURE OF THE INVENTION

As shown in Patent Documents 4 and 5, a technique to prevent addition of postscript by deactivation of photo absorbing material and discoloring are public known, however, in any case, color developing ability or decomposing ability of pigment are not sufficient, and considerable amount of photo absorbing agent is needed to obtain high recording sensitivity, further, there is an disadvantageous for operation using ultra violet ray irradiation.

Further, since these photo absorbing agent lacks stability against ray, in a case when is left in the state to be exposed in natural light (room light such as fluorescent lamp or sun light) these agents are decomposed gradually and deactivate a photo/thermal conversion ability and sufficient color developing ability can not be obtained when printed. This is a problem on actual.

Considering above mentioned situation, the object of the present invention is to provide a laser recording thermally sensitive recording medium having excellent light resistance against natural light during preservation term before actual use, having good contrast superior in laser recording aptitude such as photo recording sensitivity and scanner readout ability of recorded image to make impossible to add a postscript by precise letter or image which is specialized in laser recording.

The inventors of the present invention have conduced intensive study to dissolve the above mentioned problem and have found out that the above mentioned problem can be dissolved by following laser recording thermally sensitive recording medium. That is, a thermally sensitive recording medium comprising a thermally sensitive recording layer containing at least a photo absorbing material which absorbs laser ray and covert it to heat, an electron donating leuco dye and an electron accepting color developing agent on a substrate as main components, wherein said photo absorbing material is a compound represented by general formula (1),

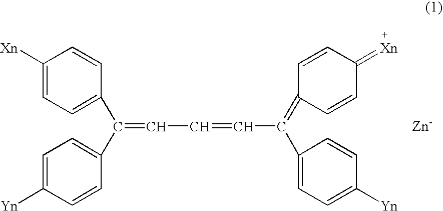

wherein, n indicates an integer from 1 to 4, and structural formula of Xn, Yn, and Zn⁻are indicated in Table 1.

TABLE 1

| | n = 1 | n = 2 | n = 3 | n = 4 |
|---|---|---|---|---|
| Xn | N(C₂H₅)₂ | N(C₂H₅)₂ | N(CH₃)₂ | N(C₂H₅)₂ |
| Yn | N(C₂H₅)₂ | N(C₂H₅)₂ | H | OCH₃ |
| Zn⁻ | 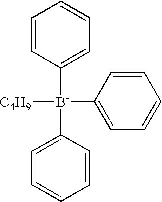 | 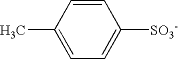 | CF₃SO₃⁻ | CF₃SO₃⁻ |

The laser recording thermally sensitive recording medium of the present invention is characterized to be excellent in recording sensitivity and colorization of background color is suppressed, because using amount of a photo absorbing agent is small. Further, since it is possible to make background color white or colorless by deactivation of photo absorbing material resulting by light irradiation, a laser recording thermally sensitive recording medium having good contrast superior in scanner readout can be prepared.

Therefore, in a plate making process of news paper, the laser recording thermally sensitive recording medium of the present invention can be used as a recording medium of new system which can replace with a printing paper, therefore it is recognized as a very useful product. Further, since said product is characterized as a recording material which makes addition of postscript impossible, it can be expected to be applied to a note because it has excellent feature for preventing the forgery such as tampering.

Further, a thermally sensitive recording medium prepared by containing a compound represented by above mentioned general formula (1) as a photo absorbing agent and an anti fading agent, or an ultra violet ray absorbing agent or an antioxidant agent (hindered amine photo stabilizing agent) has excellent light resistance against natural light too, therefore, a photo absorbing agent is not decomposed during preservation term before use, thus a laser recording thermally sensitive recording medium which can maintain stable photo/thermo converting ability for long term can be obtained. And likewise to above mentioned thermally sensitive recording medium, this laser recording thermally sensitive recording medium is characterized as follows, that is, a photo absorbing material is decomposed by irradiation of light having specific wavelength and deactivating photo/thermo converting ability and makes adding of prescript of image with high resolving degree impossible. Further, by becoming an absorption of photo absorption agent at visible light region to zero, background color part becomes white or colorless so as to have a good contrast which is excellent in a readout of recorded image by a scanner. Therefore, in a plate making of news paper, the thermally sensitive recording medium of the present invention can be used as a recording medium of new system which can be replaced with a use of a printing paper and is very useful. Furthermore, since the thermally sensitive recording medium of the present invention is characterized that the addition of postscript is impossible, it can be expected to be applied to a note because it has excellent feature for preventing the forgery such as tampering.

By adding a compound represented by general formula (2) to the thermally sensitive recording medium mentioned above as a discoloring agent,

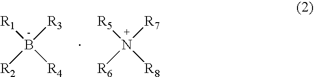

(in the formula, R₁, R₂, R₃ and R₄ are respectively independently indicating alkyl group, aryl group, allyl group, aralkyl group, alkenyl group, alkinyl group, sillyl group, heterocyclic group, substituted alkyl group, substituted aryl group, substituted allyl group, substituted aralkyl group, substituted alkenyl group, substituted alkinyl group or substituted sillyl group, at least one of R₁, R₂, R₃ or R₄ is an alkyl group of carbon number 1-12, R₅, R₆, R₇ and R₈ are respectively independently indicating hydrogen atom, alkyl group, aryl group, allyl group, aralkyl group, alkenyl group, alkinyl group, heterocyclic group, substituted alkyl group, substituted aryl group, substituted allyl group, substituted aralkyl group, substituted alkenyl group, or substituted alkinyl group),
decomposition of a compound represented by general formula (1) is remarkably accelerated and a thermally sensitive recording medium which prevents addition of postscript and tampering by deactivation of photo/thermo converting ability and has good contrast by discoloration can be easily obtained.

Further, among compounds represented by general formula (2), especially a compound represented by general formula (3) is desirable, because said compound has good discoloring ability.

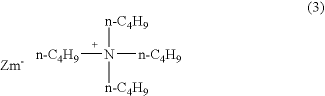

(in the formula, m indicates a integer of 1-3, and structural formulae of Zm⁻are shown in Table 2).

TABLE 2

| | m = 1 | m = 2 | m = 3 |
|---|---|---|---|
| Zm⁻ | 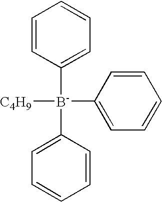 | 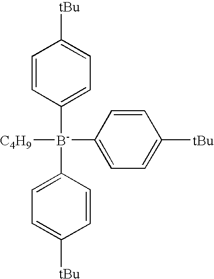 | 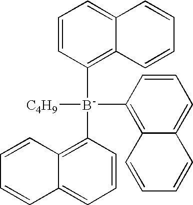 |

### DESCRIPTION OF THE PREFERRED EMBODIMENT

The present invention will be illustrated more specifically.

A photo absorbing material to be used in the present invention is a substance which absorbs the light of recording source and converts the light to heat and discharge it to the outside. Therefore, the substance which can absorb the light of recording source as broad as possible and convert it to heat and the adsorption of light which is equal to laser oscillation wave-length region (approximately 760-1100 nm) or the substance whose absorption of light having near-infrared range wave-length which is closed to laser wave-length region is especially high, is desirable from the viewpoint of heat conversion effect and generated heat quantity.

In particular, in the present invention, 4 kinds of compound represented by above mentioned general formula (1) (hereinafter, shortened to compound (1)) are used as a photo absorbing material. Light absorbing ability of compound (1) is very strong and even if the amount of use is small, photo/heat conversion can be carried out effectively. Therefore, it is considered that a thermally sensitive recording medium of high contrast can be obtained controlling coloring of background color. Further, since compound (1) has a feature to be decomposed by light irradiation, it is possible to deactivate photo/heat converting ability so as to make impossible the addition of postscript and since light absorption at visible light region becomes zero, background color becomes white or pale color, a thermally sensitive recording medium which is more excellent in contrast can be obtained.

As the light to deactivate the compound (1), light of laser wavelength region to be used for record or light of visible light wavelength region which have energy not a thermally sensitive layer to develop color is desirably used. When light of ultra violet wavelength region is used, deactivation is slightly difficult. And when the light to be used for deactivation is same as the recording wavelength, an apparatus can be simplified and is advantageous. Further, when heated by the level not a thermally sensitive layer developing color (approximately 50° C. or less) simultaneously with light irradiation, decomposition is further accelerated and is effective.

For the purpose to realize high accurate scanner readout, it is desirable that the difference of reflection ratio between image part and ground part when light of longer than 600 nm is irradiated is 60% or more, desirably 70% or more. The thermally sensitive recording medium of the present invention is characterized that the difference of absorbing intensity of image part and ground part at main wavelength for scanner readout is in good contrast.

A discoloring agent used in the present invention is a substance which decomposes and generates a radical by light irradiation. The generated radical acts effectively to compound (1), which is a light absorbing material, and acts a role to deactivate photo/thermo converting function and accelerate discoloration.

Specifically, said discoloring agent is a compound represented by above mentioned general formula (2), especially, among these compounds, 3 kinds of compounds indicated by general formula (3) are more desirable, because these compounds display good discoloring ability when used together with compound (1).

An anti fading agent used in the present invention acts to prevent gradual decomposition when is left in the condition exposed in natural light (room light such as fluorescent lamp or sun light) or acts to suppress an excess reaction with a discoloring agent. Accordingly, an anti fading agent is used aiming to prevent an actual problem, that is, photo absorbing material deactivates photo/thermo converting ability, and sufficient color developing ability can not be obtained when printed.

As a desirable anti fading agent, at least one selected from the group consisting of heat resistance antioxidant, metal oxide and metal soap can be used. The reason why the anti fading agent used in the present invention displays anti fading function is not clear, however, it is considered because a polar group such as phenolic hydroxide group, hydroquinone group or sulfone group is existing in the anti fading agent, a basic polar group is existing on the surface of metal oxide and an ionic polar group such as carboxyl group is existing in metal salt. That is, ion pair of light absorbing material of compound (1), which is an ionic complex or discoloring agent such as compound (3), becomes stable when anionic acid group exists, and stability to light or heat of these compounds is improved. Therefore, when said heat resistance antioxidant, metal oxide and metal soap are existing together with in a series which uses an light absorbing material such as compound (I) or a discoloring agent such as compound (3), excess decomposition is controlled.

As a specific example of heat resistance antioxidant, for example, hydroquinone derivatives antioxidant such as 2,5-di-t-amylhydroquinone, 2,5-di-t-butylhydroquinone or hydroquinonemonoethylether;

alkylated phenol or phenol derivatives antioxidant such as
p-hydroxymethylbenzoate, p-hydroxyethylbenzoate, p-hydroxypropylbenzoate, bis(4-dihydroxyphenyl)sulfone, 2,2-bis(4-hydroxyphenyl)propane, 3,4-dihydroxy-4′-methyldiphenylsulfone, n-methylgallate, n-propylgallate, stearylgallate, laulylgallate, resolcinol, 1-oxy-3-methyl-4-isopropylbenzene, 2,6-t-butylphenol, 2,6-di-t-butyl-4-ethylphenol, 2,6-di-t-butyl-4-methylphenol, 2,6-di-t-butyl-4-sec-butylphenol, butylhydroxyanisole, 2,6-di-t-butyl-α-dimethylamino-p-cresol, 2-(1-methylcyclohexyl)-4,6-dimethylphenol, styrenated phenol or alkylated phenol;
phosphorus acid esters antioxidant such as
1,1,3-tris-(2-methyl-4-hydroxy-5-t-butylphenylbutane, 4,4′-butylidenebis-(3-methyl-6-t-butylphenol), 2,2-thiobis(4′-hydroxy-3′,5′-di-t-butylphenyl)phosphite, tris(mix mono and di-nonylphenyl)phosphite, phenyldiisodecylphosphite, diphenylmono(2-ethylhexyl)phoaphite, diphenylmonotridecylphosphite, diphenylisodecylphosphite, diphenylisooctylphosphite, diphenylisooctylphosphite, triphenylphosphite, tris(tridecyl)phosphate or tetraphenyldipropyleneglycolphosphite can be mentioned. These heat resistance antioxidants can be used alone or as a mixture of 2 or more.

Among these heat resistance antioxidants, p-hydroxymethylbenzoate, p-hydroxyethylbenzoate, bis(4-dihydroxyphenyl)sulfone, 2,2-bis(4-hydroxyphenyl)propane, 3,4-dihydroxy-4′-methyldiphenylsulfone, n-methylgallate, n-propylgallate, stearylgallate, laulylgallate or resolcinol are desirable, because these compounds are superior in transparency and whiteness.

Amount of heat resistance antioxidant as an anti fading agent to be used is 0.1-500 weight parts, desirably 0.5 to 100 weight parts to 1 weight part of photo absorbing material. When amount of heat resistance antioxidant is too small, preventing effect for color fading is not sufficient and when amount is too much, coloring is obstructed and sensitivity is deteriorated.

As a specific example of above mentioned metal oxide, for example, MgO, Al₂O₃, SiO₂, Na₂O, SiO₂.MgO, SiO₂.Al₂O₃, Al₂O₃.Na₂O.CO₂ or MgO.Al₂O₃.CO₂ can be mentioned. These compounds can be used alone or together with. Among these metal oxides, MgO, mixture of MgO and SiO₂ or Al₂O₃, Na₂O, SiO₂.MgO, SiO₂.Al₂O₃, Al₂O₃.Na₂O.CO₂ or MgO.Al₂O₃.CO₂ are especially superior in anti fading ability and are desirably used.

Amount of metal oxide as an anti fading agent to be used is 0.1-500 weight parts, desirably 0.5 to 100 weight parts to 1 weight part of photo absorbing material. When amount of heat resistance antioxidant is too small preventing effect for fading is not sufficient and when amount is too much coloring is obstructed and sensitivity is deteriorated.

As a specific example of above mentioned metal soap, stearic acid salt such as lithium stearate, magnesium stearate, aluminum stearate, calcium stearate, strontium stearate, barium stearate, zinc stearate, cadmium stearate or lead stearate, lauric acid salt such as cadmium laurate, calcium laurate or barium laurate, chlorostearic acid salt such as calcium chlorostearate, barium chlorostearate or cadmium chlorostearate, 2-ethylhexyl acid salt such as barium 2-ethylhexylate, zinc 2-ethylhexylate or lead 2-ethylhexylate, recinolic acid salt such as barium recinolate, zinc recinolate or cadmium recinolate, lead di-basic stearate such as 2PbO.Pb(C₁₇H₃₅COO)₂; salicylate such as lead salicylate, tin salicylate, zinc salicylate or chrome salicylate; lead tri-basicsalicylate such as 3PbO.Pb(C₄H₃₅COO)₂; lead tri-basic malate such as 3PbO.Pb(CH₂O₄)₂; lead di-basic phthalate such as 2PbO.Pb(C₈H₃₅COO)₂, lead di-basic phthalate can be mention. These metallic soap can be used alone or together with. In these mentioned metallic salt, zinc stearate, calcium stearate, magnesium stearate, calcium laurate, zinc salicylate, zinc recinolate, balium zinc recinolate or barium 2-ethylhexylate are desirable from a view point of whiteness.

Amount of metallic soap to be used is 0.1-500 weight parts, desirably 0.5 to 100 weight parts to 1 weight part of photo absorbing material. When amount of heat resistance antioxidant is too small preventing effect for fading is not sufficient and when amount is too much, coloring is obstructed and sensitivity is deteriorated.

As a specific example of an ultra violet ray absorbing agent, for example, benzophenones ultra violet ray absorbing agent such as 4-hydroxybensophenone, 2-hydroxy-4-methoxybenzophenone, 2-hydroxy-4-octoxybenzophenone, 2-hydroxy-4-dodecylxybenzophenone, 2,2′-dihydroxy-4-methoxybenzophenone or 2,2′-dihydroxy-4,4′-dimethoxybenzophenone, salicylic acids ultra violet ray absorbing agent such as phenyl salicylate, p-t-butylphenylsalicilate or p-octylphenylsalicilate, triazoles ultra violet ray absorbing agent such as 2-(2′-hydroxy-5′-methylphenyl)benzotriazole, 2-(2′-hydroxy-5′-t-butylphenyl)benzotriazole, 2-(2′-hydroxy-3′-t-butyl-5′-methylphenyl)-5-chlorobenzotriazole <Tomisoap600>, 2-(2′-hydroxy-3′,5′-di-t-butylphenyl)-5-chlorobenzotriazole, 2′-[2′-hydroxy-3′-(3″,4″,5″,6″-tetra hydrophthalimidemethyl)-5′-methylphenyl]benzotriazole, 2,2-methylene bis[4-(1,1,3,3-tetramwthylbutyl)-6-(2H-benzotriazole-2-yl)phenol <Adeca stabLA-31>, aqueous emulsion polymer ultra violet ray absorbing agents disclosed in JP 2001-150810 or benzooxadinones ultra violet ray absorbing agents can be mentioned, and these agents can be used alone or together with.

The reason why these ultra violet ray absorbing agents used in the present invention displays color fading preventing function is not clear, however, it is conjectured as follows. That is, a photo absorbing material such as compound (1) lacks stability to natural light, and by adding an ultra violet absorbing agent together with, total integrated amount of light irradiated to the photo absorbing material is remarkably reduced and color fading, accordingly deterioration of photo absorbing material is prevented.

Further, in general, since an electron donating leuco dye changes color to yellowish by being exposed in the natural light, when the photo absorbing material is discolored and ground part of paper becomes achromatic, said yellowish color change deteriorates appearance of a product and becomes a ground to injure the impression. However, by adding above mentioned ultra violet ray absorbing agent, not only color fading of photo absorbing material but also yellowish color change of leuco dye is greatly prevented, and a good contrast can be obtained.

Among these mentioned ultra violet ray absorbing agent, compound having triazole structure is desirable, because said compound has high ultra violet ray absorbing ability and is superior in preventing ability of color fading.

Blending amount of an ultra violet ray absorbing agent is 1-500 weight parts desirably 1-300 weight parts to 1 weight part of photo absorbing agent to be used. When the amount is too small, the preventing ability for color fading is not sufficient and when the amount is too much, not only further improvement of preventing ability for color fading can not be expected but also producing cost becomes higher.

Hindered amines photo stabilizing agent used in the present invention is used for the purpose to prevent remarkably deterioration of photo absorbing material and yellowish color change of leuco dye by obstructing activity of excess radicals generated when exposed to natural light, especially it's effect is remarkable when used together with an ultra violet ray absorbing agent. The reason of above mentioned phenomenon is not clear, however, it is conjectured as follows. That is, an ultra violet ray absorbing agent absorbs ray of ultra violet region contained in natural light, and activity of radicals generated by ray of different region or by unabsorbed ultra violet ray is obstructed by a hindered amines photo stabilizing agent, and the hindered amines photo stabilizing agent is acting effectively to prevent discoloration of a photo absorbing material and to prevent yellowish color change of leuco dye.

As a specific example of hindered amines photo stabilizing agent, for example, hindered amine compound such as polycondensated product of 1,6-bis(2,2,6,6-tetramethyl-4-piperidil amino)hexane and dibromoethane, polycondensated product of 1,6-bis(2,2,6,6-tetramethyl-4-piperidil amino) hexane and 2,4-dichloro-6-morpholino-s-triazine, polycondensated product of 1,6-bis(2,2,6,6-tetramethyl-4-piperidil amino)hexane, polycondensated product of 1,6-bis(2,2,6,6-tetramethyl-4-piperidilamino)hexane and 2,4-dichloro-6-tertiaryoctylamino-2,4-s-triazine, 1,5,8,12-tetrakis[2,4-bis(N-butyl-N-(2,2,6,6-tetramethyl-4-piperidilamino)-s-triazine-6-yl)-1,5,8,12-tetraazadodecane, 1,5,8,12-tetra-tetraxis[2,4-bis(N-butyl-N-(1,2,2,6,6′-pentamethyl-4-piperidilamino)-s-triazine-6-yl-1,5,8,12-tetraazadodecane, 1,6,11-tris[2,4bis(N-butyl-N-(2,2,6,6-tetramethyl-4-piperidil)amino)-s-triazine-6-yl aminoundecane, 1,6,11-tris[2,4bis(N-butyl-N-(2,2,6,6-pentamethyl-4-piperidil)amino)-s-triazine-6-ylaminoundecane can be mentioned. These compounds can be used alone or together with. Especially, (2,2,6,6-tetramethyl-4-piperidil/tridecyl)-1,2,3,4-butanetetracarboxylate and tetrakis(2,2,6,6-tetramethyl-4-piperidil)-1,2,3,4-butanetetracarboxylate are desirable.

Blending amount of a hindered amines photo stabilizing agent is 1-500 weight parts desirably 1-300 weight parts to 1 weight part of photo absorbing agent to be used, and is 0.1-50 weight parts desirably 0.1-10 weight parts to 1 weight part of ultra violet ray absorbing agent. When the amount is too small, the preventing ability for color fading is not sufficient and when the amount is too much, color developing ability may be obstructed.

As an electron donating leuco dye used in the present invention, any public known compound can be used. These compounds can be used alone or together with, and suitably selected along with the required quality or characteristics. As a specific example, following compounds can be mentioned, however, not intending to be limited to them.

### (1) Triarylmethane Compound

3,3′-bis(4-dimethylaminophenyl)-6-dimethylaminophthalide <commodity name; Crystal Violet Lacton, CVL>,
3-(4-dimethylamino-2-methylphenyl)-3-(4-dimethylaminophenyl)phthalide,
3,3′-bis(2-4(-dimethylaminophenyl)-2-(4-methoxyphenyl)ethenyl)-4,5,6,7-tetrachlorophthalide <NIR-Black>,
3,3′-bis(4-dimethylaminophenyl)phthalide <MGL>,
3-(4-dimethylaminophenyl)-3-(1,2-dimethylindol-3-yl)phthalide,
3-(4-dimethylaminophenyl)-3-(2-phenylindol-3-yl)phthalide,
3,3′-bis(4-ethylcarbazole-3-yl)-3-dimethylaminophthalide,
3,3′-bis(1-ethyl-2-methylindole-3-yl)phthalide <Indolyl Red>,
3,3′-bis(2-phenylindole-3-yl)-5-dimethylamonophthalide,
tris(4-dimethylaminophenyl)methane <LCV> and others.

### (2) Diphenylmethane Compound

4,4-bis(dimethylamino)benzhydrinebenzylether,
N-halophenyl-leucoauramine,
N-2,4,5-trichlorophenyl-leucoauramine and others.

### (3) Xanthene Compound

rhodamineB-anilinolactam,
3-diethylamino-7-dibenzylaminofluorane,
3-diethylamino-7-butylaminofluorane,
3-diethylamino-7-anilinofluorane <Green-2>,
3-diethylamino-7-(2-chloroanilino)fluorane,
3-dibutylamino-7-(2-chloroanilino)fluorane <Th-107>,
3-diethylamino-7-(3-trifluoromethylanilino)fluorane <Black-100>,
3-diethylamino-6-methyl-7-anilinofluorane <OBD>,
3-dibutylamino-6-methyl-7-anilinofluorane <OBD-2>,
3-piperidino-6-methyl-7-anilinofluorane,
3-(N-isoamyl-N-ethylamino)-6-methyl-7-anilinofluorane <S-205>,
3-(N-ethyl-N-tolylamino)-6-methyl-7-anilinofluorane,
3-(N-cyclohexyl-N-methylamino)-6-methyl-7-anilinofluorane <PSD-150>,
3-diethylamino-6-chloro-7-(β-ethoxyethylamino)fluorane,
3-diethylamino-6-chloro-7-(γ-chloropropylamino)fluorane,
3-cyclohexylamino-6-chlorofluorane <OR-55>,
3-diethylamino-6-chloro-7-anilinofluorane,
3-(N-cyclohexyl-N-methylamino)-6-methyl-7-anilinofluorane,
3-diethylamino-7-phenylfluorane and others.

### (4) Thiazine Compound

benzoylleucomethylene blue,
p-nitrobenzoylleucomethylene blue and others.

### (5) Spiro Compound

3-methylspirodinaphthopyrane,
3-ethylspirodinaphthopyrane,
3-benzylspirodinaphthopyrane or
3-methylnaphtho-(6′-methoxybenzo)spiropyrane can be mentioned.

### (6) Pentadiene Compound

1,1,5,5-tetrakis(4-dimethylaminophenyl)-3-methoxy-1,4-pentadiene,
1,1,5,5-tetrakis(4-dimethylaminophenyl)-1,4-pentadiene and others.

Almost all leuco dyes mentioned above absorbs light of visible light region, further mainly absorbs light of wavelength smaller than 600 nm. In the present invention, besides above mentioned leuco dye, the leuco dye which has the main wave length of absorption to the ray longer than 600 nm is used. Especially, the leuco dye which indicates strong absorption to the wave length of 600-700 nm is desirably used. As a specific example of said leuco dye, fluorane leuco dye and/or phthalide leuco dye are desirably used. As a fluorane leuco dye, 3-(N-p-tolyl-N-ethylamino)-(1′-N-ethyl-2′,2′,4′-trimethylpyridil)-[a]-fluorane <H-1046> can be mentioned. Further, as the phthalide leuco dye, 3,3-bis(4-diethylamino-2-ethoxyphenyl)-4-azaphthalide <GN-2>, 3,6,6′-tris(dimethylamino)spiro[fluorene-9,3′-phthalide]<Green-118> or 3,3-bis(2-(4-diethylaminophenyl)-2-(4-methoxyphenyl)ethenyl)4,5,6,7-tetrachlorophthalide <NIR-Black> can be mentioned.

As an electron accepting color developing agent used in the present invention, inorganic acidity compound such as activated clay, attapulgite, colloidal silica or aluminum silicate,
A 4-hydroxybenzoic acid esters such as
4-hydroxybenzylbenzoate,
4-hydroxyethylbenzoate,
4-hydroxynormalpropylbenzoate,
4-hydroxyisopropylbenzoate or
4-hydroxybutylbenzoate,
4-hydroxyphthalic acid diesters such as
4-hydroxydimethylphthalate,
4-hydroxydiisopropylphthalate,
4-hydroxydibenzylphthalate or
4-hydroxydihexylphthalate,
a phthalic acid monoesters such as
monobenzylphthalate,
monocyclohexylphthalate,
monophenylphthalate or
monomethylphenylphthalate,
bishydroxyphenylsulfides such as
bis-(4-hydroxy-3-tert-butyl-6-methylphenyl)sulfide,
bis-(4-hydroxy-2,5-dimethylphenyl)sulfide or
bis-(4-hydroxy-5-ethyl-2-methylphenyl)sulfide,
bisphenols such as
3,4-bisphenol A,
1,1-bis(4-hydroxyphenyl)ethane,
2,2-bis(4-hydroxyphenyl)propane <bisphenol A>,
bis(4-hydroxyphenyl)methane <bisphenol F>,
2,2-bis(4-hydroxyphenyl)hexane,
tetramethyl bisphenol A,
1,1-bis(4-hydroxyphenyl)-1-phenylethane,
1,4-bis(2-(4-hydroxyphenyl)propyl)benzene,
1,3-bis(2-(4-hydroxyphenyl)propyl)benzene,
1,4-bis(4-hydroxyphenyl)cyclohexane,
2,2′-bis-(4-hydroxy-3-isopropylphenyl)propane or
1,4-bis(1-(4-(2-(4-hydroxyphenyl)-2-propyl)phenyl)ethyl)benzene,
4-hydroxyphenylarylsulfones such as
4-hydroxy-4′-isopropoxydiphenylsulfone <D-8>,
4-hydroxy-4′-methoxydiphenylsulfone or
4-hydroxy-4′-normalpropoxydiphenylsulfone,
bishydroxyphenylsulfone such as
bis(4-hydroxyphenyl)sulfone <bisphenol S>,
tetramethyl bisphenol S,
bis(3-ethyl-4-hydroxyphenyl)sulfone,
bis(3-propyl-4-hydroxyphenyl)sulfone,
bis(3-isopropyl-4-hydroxyphenyl)sulfone,
bis(3-tert-butyl-4-hydroxy-6-methylphenyl)sulfone,
bis(3-chloro-4-hydroxyphenyl)sulfone,
bis(3-bromo-4-hydroxyphenyl)sulfone,
2-hydroxyphenyl-4′-hydroxyphenylsulfone
4-hydroxyphenylarylsulfonate such as
4-hydroxyphenylbenzenesulfonate,
4-hydroxyphenyl-p-tolylsulfonate or
4-hydroxyphenyl-p-chlorobenzenesulfonate,
4-hydroxybenzoyloxybenzoic acid esters such as
4-hydroxybenzoyloxybenzylbenzoate,
4-hydroxybenzoyloxyethylbenzoate,
4-hydroxybenzoyloxynormalpropylbenzoate,
4-hydroxybenzoyloxyisopropylbenzoate or
4-hydroxybenzoyloxybutylbenzoate,
benzophenones such as
2,4-dihydroxybenzophenone,
α,α′-bis-(3-methyl-4-hydroxyphenyl)-m-diisopropylbenzophenone or
2,3,4,4′-tetrahydroxybenzophenone,
phenolic compounds such as
N-stearyl-p-aminophenol,
4-hydroxysalicylanilido,
4,4′-dihydroxydiphenylether,
n-butylbis(hydroxyphenyl)acetate,
α,α′,α″-tris(4-hydroxyphenyl)-1,3,5-triisopropylbenzene,
stearylgallate,
4,4′-thiobis(6-t-butyl-m-cresol),
2,2-bis(3-allyl-4-hydroxyphenyl)sulfone,
bis(4-hydroxyphenyl)sulfide,
bis(4-hydroxy-3-methylphenyl)sulfide,
p-tert-butylphenol,
p-phenylphenol,
p-benzylphenol,
1-naphthol or
2-naphthol,
thiourea compound such as
N,N′-di-m-chlorophenylthiourea,
aromatic carboxylic acid such as
benzoic acid,
p-tert-butyl benzoate,
trichloro benzoate,
3-sec-butyl-4-hydroxy benzoate
3-sec-cyclohexyl-4-hydroxy benzoate,
3,5-dimethyl-4-hydroxy benzoate,
terephthalic acid,
salicylic acid,
3-isopropyl salicylate,
3-tert-butyl salicylate,
4-(2-(p-methoxyphenoxy)ethyloxy salicylate,
4-(3-(p-tolylsulfonyl)propyloxy salicylate or
5-(p-(2-(p-methoxyphenoxy)ethoxy)coumyl salicylate or
4-(3-(tolylsulfonyl)propyloxy salicylate, and salt of these aromatic carboxylic acid with polyvalent metal such as zinc, magnesium, aluminum, calcium, titanium, manganese, thin or nickel, further, organic acidic compound such as
   antipyrine complex of zincthiocyanate or
   complex zinc salt of terephtalicaldehyde acid with other organic carboxylic acid can be mentioned. These compounds can be used alone or can be used together with. In particular, among these compounds, bishydroxyphenylsulfones such as bis(4-hydroxyphenyl)sulfone <bisphenol S> or 4-hydroxyphenylarylsulfones such as 4-hydroxy-4′-isopropoxy dipehnylsulfone are desirable.

In the conventional thermally sensitive recording medium, a sensitizer is used aiming the improvement of sensitivity. In the thermally sensitive recording medium of the present invention, a sensitizer can be added in a thermally sensitive recording layer in response to the purpose. The concrete examples of the sensitizer are mentioned below, however not intending to be limited to them, and these sensitizers can be used together with. As the examples,
stearic acid amide,
methoxycarbonyl-N-steric acid benzamide,
N-benzoylstearic acid amide,
N-eicosanoic acid amide,
ethylene bis stearic acid amide,
behenic acid amide,
methylenebis stearic acid amide,
methylolamide,
N-methylol stearic acid amide,
dibenzylterephthalate,
dimethylterephthalate,
dioctylterephthlate,
p-benzyloxybenzoic benzyl,
1-hydroxy-2-naphthoic acid phenyl,
dibenzyloxalate,
di-p-methylbenzyloxalate,
di-p-chlorobenzyloxalate,
2-naphthylbenzyl ether,
m-tarphenyl,
p-benzylbiphenyl,
1,2-bis(phenoxymethyl)benzene <PMB-2>,
tolylbiphenyl ether,
di(p-methoxyphenoxyethyl)ether,
1,2-di(3-methylphenoxy)ethane,
1,2-di(4-methylphenoxy)ethane,
1,2-di(4-methoxyphenoxy)ethane,
1,2-di(4-clorophenoxy)ethane,
1,2-diphenoxyethane,
1-(4-methoxyphenoxy)-2-(2-methylphenoxy)ethane,
p-methylthiophenylbenzyl ether,
1,4-di(phenylthio)butane,
p-acetotoluidido,
p-acetophenetidido,
N-acetoacethyl-p-toluidine,
di(-biphenylethoxy)benzene,
p-di(vinyloxyethoxy)benzene and
1-isopropylphenyl-2-phenylethane
   can be mentioned. Ordinary, 0.1 to 10 weight parts of these mentioned sensitizers is used to 1 weight part of an electron donating leuco dye.

To the thermally sensitive recording medium of the present invention, a preserving stabilizer can be used for the purpose of stabilization of the long term preservation. As the concrete examples of the preserving stabilizer, hindered phenol compound such as
1,1,3-tris(2-methyl-4-hydroxy-5-tert-butylphenyl)butane,
1,1,3-tris(2-methyl-4-hydroxy-5-cyclohehylphenyl)butane,
4,4′-butylidenebis(2-tert-butyl-5-methylphenol),
4,4′-thiobis(2-tert-butyl-5-methylphenol),
2,2′-thiobis(6-tert-butyl-4-methylphenol) or
2,2′-methylenebis(6-tert-butyl-4-methylphenol),
4-benzyloxy-4′-(2-methylglycidiloxy)diphenylsulfone or
sodium-2,2′-methylenebis(4,6-di-tert-butylphenyl)phosphete
   can be mentioned. Ordinary, 0.1 to 10 weight parts of these mentioned preserving sensitizers is used to 1 weight part of electron donating leuco dye.

As a specific example of a binder used in the present invention, water soluble binder such as starches, hydroxyethyl cellulose, methyl cellulose, carboxymethyl cellulose, gelatin, casein, gum arabic, polyvinylalcohol, denatured polyvinyl alcohol by carboxyl, denatured polyvinyl alcohol by acetoacetyl group, denatured polyvinyl alcohol by silicon, alkaline salt of isobutylene-maleic anhydride copolymer, alkaline salt of styrene-maleic anhydride copolymer, alkaline salt of ethylene-maleic anhydride copolymer or alkaline salt of styrene-acrylic acid copolymer, latexes such as styrene-butadiene copolymer or acrylonitrile-butadiene copolymer, water dispersible binder such as urea resin, melamine resin, amide resin or polyurethane resin can be mentioned. At least one kind of these mentioned binder is used by 15-80 weight % to the total solid weight in a thermally sensitive layer, an over coat layer, an intermediate layer, an undercoat layer and a back coat layer.

As a filler, an inorganic filler such as activated clay, clay, calcined clay, talc, kaoline, calcined kaoline, calcium carbonate, magnesium carbonate, barium carbonate, titanium dioxide, zinc oxide, silicone oxide or aluminum hydroxide, or an organic filler such as urea-formaldehyde resin, polystyrene resin or phenol resin can be used.

Still more, dispersing agent such as sodiumdioctylsulfosuccinate, surface active agent, defoamer, fluorescent brightening agent, slipping agent, UV absorbing agent or antioxidant can be used if desired.

As a substrate used for the thermally sensitive recording medium of the present invention, paper such as wood free paper, middle grade paper, recycled paper or coated paper can be mainly used, however, various non-woven cloth, plastic film, synthetic paper metal foil or a complex sheet combining these sheets can be also suitably used.

Furthermore, it is possible to form an over coat layer composed of polymer compound over the thermally sensitive recording layer for the purpose to improve the preserving property, and an under coat layer composed of polymer compound containing a filler under the thermally sensitive recording layer for the purpose to improve the color developing sensitivity. It is also possible to form an intermediate layer between the thermally sensitive recording layer and the over coat layer.

The thermally sensitive recording medium of the present invention can be prepared according to the conventional well-known method using various materials mentioned above. Regarding the method for preparation of a coating for each layers of the thermally sensitive recording material is not restricted, and generally can be prepared by miing and stirring photo absorbing material, electron donating leuco dye, electron receiving color developing agent, additionally, binder and filler and slipping agent which are added when the need is arisen, using water as a dispersing medium. As the method to prepare an aqueous coating using leuco dye and a color developing agent, following methods can be mentioned. The method to pulverize leuco dye and a color developing agent separately using a sand grinder, an attriter or a ball mill and disperse them in water then mixing together, or the method to prepare micro capsules in which leuco dye or a color developing agent is immobilized then obtain aqueous coating are well-known. The ratio of using amount of leuco dye and a color developing agent is suitably selected according to the kind of leuco dye and a color developing agent and is not particularly restricted, however, 1-50 weight parts, desirably 0.1-10 weight parts of color developing agent is used to 1 weight part of leuco dye.

Regarding a photo absorbing material, in the present invention, even if the using amount is small, specifically less than 0.1 weight parts to 1 weight part of leuco dye, excellent color developing ability can be obtained. Especially; approximately 0.01-0.08 weight parts is desirable. To total solid part of thermally sensitive recording layer, using amount of a photo absorbing material is 0.5-5 weight % desirably 0.05-3 weight %. A discoloring agent is used about 0.01-3 weight parts, desirably 0.05-10 weight parts to 1 weight part of photo absorbing material. In the present invention, when the photo absorbing material is used together with a sensitizer by previously dispersed, dissolved or fused, the photo absorbing property can be enhanced, therefore said method is effective. Further, it is desirable that the photo absorbing material is pulverized to fine particles smaller than 3 μm of average particle size after dispersed or mixed with a sensitizer. As a sensitizer, same ones used in the thermally sensitive recording layer can be used.

It is desirable to pulverize a near-infrared ray absorbing agent and color developing materials (leuco dye, color developing agent, sensitizer) to fine particles whose average particle size is not to exceed 3 μm. The reason why is thought as follows. That is, by pulverizing materials finer, the dot size of color developed printed part becomes same size to the size of spot of laser ray, which is ray source, and forms uniform dots, and clear printing or a line drawing suited for the readout by a scanner are obtained.

The method for forming of each layer of thermally sensitive recording layer is not restricted and methods such as air knife coating, Valiber blade coating, pure blade coating, rod blade coating, short dwell coating, curtain coating or die coating can be voluntarily selected. For example, a coating for thermally sensitive recording layer is coated on a substrate and dried, then a coating for over coat layer is coated over the thermally sensitive recording layer and dried. Further, the coating amount of the coating for thermally sensitive recording layer is approximately 2-12 g/m², desirably 3-10 g/m² by dry weight and, the coating amount of the coating for under coat layer, intermediate layer or over coat layer is approximately 0.1-15 g/m², desirably 0.5-10 g/m² by dry weight.

Furthermore, the thermally sensitive recording medium of the present invention is possible to provide a back coat layer at the reverse side of the substrate so as to improve the preservability more. Still further, after each layer is formed, it is possible carry out the smoothing treatment such as super calendaring.

And the process for discoloring is carried out by irradiating light to whole surface after image recording. Wavelength of said light to be irradiated is preferably visible light of 600 nm or near-infrared ray of 800 nm. Further, it is desirable to carry out heat treatment of level which does not develop color at same time, because by said heat treatment, discoloring is accelerated.

### EXAMPLE

The present invention will be illustrated more specifically according to the Examples and the Comparative Examples, however, not intended to be limited by them. In the Examples and the Comparative Examples, “parts” and “%” indicate “weight parts” and “weight %”.

### Evaluation Test

To the laser recording thermally sensitive recording media obtained in Examples 1-18 and Comparative Example 1-2, recording by laser is carried out using dry plotter-GX-3700 (wavelength 830 nm), which is a product of Matsushita Electric Works Graphic Printing Ltd., and the color density of the printed part and the background color part are measured by Macbeth densitometer RD-19.

After that, whole surface is irradiated by a visible light lamp of 600 nm wavelength, so as to deactivate the photo absorbing material and to make achromatic (discolor) and the color density of background color part is measured by Macbeth densitometer RD-19.

Further, readability when readout by a scanner (readout wavelength is 630 nm) is indicated as,

◯: can be readout well

x: accuracy for readout is bad (or can not be readout)

Further, after the laser recording thermally sensitive recording medium is discolored, laser recording process is carried out again, and a preventing ability for forgery (“addition of a postscript is impossible” is good) is indicated as,

◯: not develop color, addition of a postscript is impossible

Δ: slightly develops color

x: develops color and a postscript is possible

### Example 1

A Solution (Dispersion of Color Developing Agent)

| | |
|---|---|
| 4-hydroxy-4′-isopropoxydephenylsulfone <D-8> | 6.0 parts |
| 10% aqueous solution of polyvinylalcohol | 20.0 parts |
| water | 10.0 parts |

Mixture of above mentioned components is ground to average particle size of 1 μm using a sand grinder.

B Solution (Dispersion of Photo Absorbing Material)

Photo absorbing agent represented by following structural formula (1)

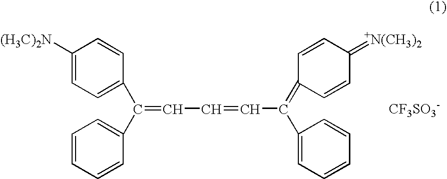

| | |
|---|---|
| <product of Showa Denko Co., Ltd., IR2MF> | 0.3 parts |
| 1,2-bis(phenoxymethyl)benzene <PMB-2> | 5.0 parts |
| 10% aqueous solution of polyvinylalcohol | 10.0 parts |
| water | 6.0 parts |

Mixture of above mentioned components is ground to average particle size of 1 μm using a sand grinder.

C Solution (Dispersion of Discoloring Agent)

Discoloring agent represented by following structural formula (2)

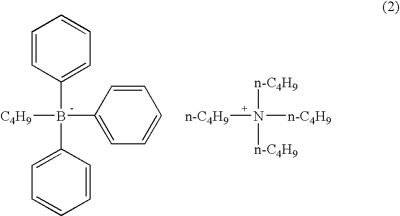

| | |
|---|---|
| <product of Showa Denko Co., P3B> | 0.3 parts |
| 1,2-bis(phenoxymethyl)benzene <PMB-2> | 5.0 parts |
| 10% aqueous solution of polyvinylalcohol | 10.0 parts |
| water | 6.0 parts |

Mixture of above mentioned components is ground to average particle size of 1 μm using a sand grinder.

D solution (Dispersion of dye)

| | |
|---|---|
| 3-dibutylamino-6-methyl-7-anilino fluorane <OBD-2> | 3.0 parts |
| 10% aqueous solution of polyvinylalcohol | 5.0 parts |
| water | 2.0 parts |

Mixture of above mentioned components is ground to average particle size of 1 μm using a sand grinder.

Then above mentioned dispersions are mixed by the following ratio and a coating is obtained.

| | | |
|---|---|---|
| A solution | 40.0 | parts |
| B solution | 5.0 | parts |
| C solution | 10.0 | parts |
| D solution | 10.0 | parts |
| 30% silica dispersion | 30.0 | parts |

The obtained coating is coated on one surface of 60 g/m² paper so as the coating amount to be 7.0 g/m² and dried, and the laser recording thermally sensitive recording medium is prepared (in a thermally sensitive recording layer, using amount of photo absorbing material is 0.02 parts to 1 part of leuco dye).

### Example 2

By the same process as Example 1 except changing the discoloring agent of Example 1 to following discoloring agent represented by following structural formula, a laser recording thermally sensitive recording medium is obtained.

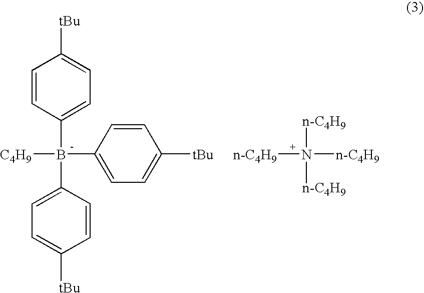

<product of Showa Denko Co., Ltd., BP3B>

### Example 3

By the same process as Example 1 except changing the discoloring agent of Example 1 to following discoloring agent represented by following structural formula, a laser recording thermally sensitive recording medium is obtained.

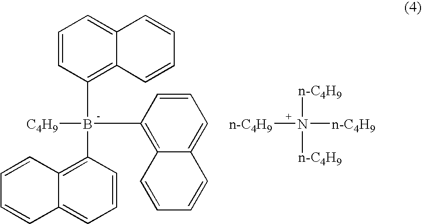

<product of Showa Denko Co., Ltd., N3B>

### Example 4

By the same process as Example 1 except not using C solution (discoloring agent), a laser recording thermally sensitive recording medium is obtained.

### Example 5

By the same process as Example 1 except changing the photo absorbing material of Example 1 to following photo absorbing material represented by following structural formula, a laser recording thermally sensitive recording medium is obtained.

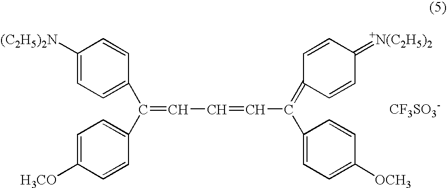

<product of Showa Denko Co., Ltd., IR13F>

### Example 6

By the same process as Example 2 except changing the photo absorbing material of Example 2 to IR13F (product of Showa Denko Co., Ltd.), a laser recording thermally sensitive recording medium is obtained.

### Example 7

By the same process as Example 3 except changing the photo absorbing material of Example 3 to IR13F (product of Showa Denko Co., Ltd.), a laser recording thermally sensitive recording medium is obtained.

### Example 8

By the same process as Example 4 except changing the photo absorbing material of Example 1 to IR13F (product of Showa Denko Co., Ltd.), a laser recording thermally sensitive recording medium is obtained.

### Example 9

By the same process as Example 1 except changing the photo absorbing material of Example 1 to following photo absorbing material represented by following structural formula, a laser recording thermally sensitive recording medium is obtained.

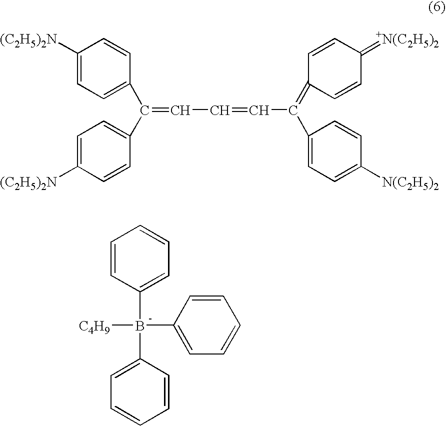

<product of Showa Denko Co., Ltd. IRB>

### Example 10

By the same process as Example 2 except changing the photo absorbing material of Example 2 to IRB (product of Showa Denko Co., Ltd.), a laser recording thermally sensitive recording medium is obtained.

### Example 11

By the same process as Example 3 except changing the photo absorbing material of Example 3 to IRB (product of Showa Denko Co., Ltd.), a laser recording thermally sensitive recording medium is obtained.

### Example 12

By the same process as Example 4 except changing the photo absorbing material of Example 4 to IRB (product of Showa Denko Co., Ltd.), a laser recording thermally sensitive recording medium is obtained.

### Example 13

By the same process as Example 1 except changing the photo absorbing material of Example 1 to following photo absorbing material represented by following structural formula, a laser recording thermally sensitive recording medium is obtained.

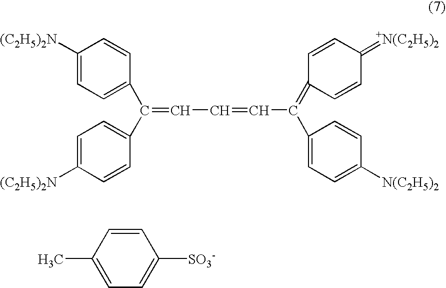

<product of Showa Denko Co., Ltd. IRT>

### Example 14

By the same process as Example 2 except changing the photo absorbing material of Example 2 to IRT (product of Showa Denko Co., Ltd.), a laser recording thermally sensitive recording medium is obtained.

### Example 15

By the same process as Example 3 except changing the photo absorbing material of Example 3 to IRT (product of Showa Denko Co., Ltd.), a laser recording thermally sensitive recording medium is obtained.

### Example 16

By the same process as Example 4 except changing the photo absorbing material of Example 4 to IRT (product of Showa Denko Co., Ltd.), a laser recording thermally sensitive recording medium is obtained.

### Example 17

Besides A, B, C and D solutions of Example 1, E solution is prepared. E solution (Dispersion of leuco dye which absorbs light of 600-700 nm wavelength)

| | |
|---|---|
| 3,3-bis(4-diethylamino-2-ethoxyphenol)-4-azaphthalide | 1.0 part |
| <GN-2> | |
| 10% aqueous solution of polyvinylalcohol | 5.0 parts |
| water | 2.0 parts |

Mixture of above mentioned components is ground to average particle size of 1 μm using a sand grinder.

Then above mentioned dispersions are mixed by the following ratio and a coating is obtained.

| | |
|---|---|
| A solution | 40.0 parts |
| B solution | 5.0 parts |
| C solution | 10.0 parts |
| D solution | 10.0 parts |
| E solution | 10.0 parts |
| 30% silica dispersion | 30.0 parts |

The obtained coating is coated on one surface of 60 g/m² paper so as the coating amount to be 7.0 g/m² and dried, and the laser recording thermally sensitive recording medium is prepared.

### Example 18

On the laser recording thermally sensitive recording medium obtained in Example 1 laser recording is carried out and by the same method as Example 1 except using an ultra violet ray lamp of wavelength 360 nm at discoloration process, evaluation test is carried out.

### Comparative Example 1

By the same process as Example 1 except changing the photo absorbing material of Example 1 to CY-20 (product of Nihon Kayaku Co., Ltd., cyanine photo absorbing material), a laser recording thermally sensitive recording medium is obtained.

### Comparative Example 2

By the same process as Example 1 except changing the photo absorbing material of Example 1 to NK-6288 (product of Hayashi Protist Chemical Laboratory, cyanine photo absorbing material), a laser recording thermally sensitive recording medium is obtained.

Photo absorbing materials and discoloring agents used in above Examples and Comparative Examples are summarized in Table 3 and results are summarized in Table 4.

TABLE 3

| | Photo absorbing | Discoloring |
|---|---|---|
| | material | agent |
| Example 1 | IR2MF | P3B |
| Example 2 | IR2MF | BP3B |
| Example 3 | IR2MF | N3B |
| Example 4 | IR2MF | — |
| Example 5 | IR13F | P3B |
| Example 6 | IR13F | BP3B |
| Example 7 | IR13F | N3B |
| Example 8 | IR13F | — |
| Example 9 | IRB | P3B |
| Example 10 | IRB | BP3B |
| Example 11 | IRB | N3B |
| Example 12 | IRB | — |
| Example 13 | IRT | P3B |
| Example 14 | IRT | BP3B |
| Example 15 | IRT | N3B |
| Example 16 | IRT | — |
| Example 17 | IR2MF | P3B |
| Example 18 | IR2MF | P3B |
| Comparative Example 1 | CY-20 | P3B |
| Comparative Example 2 | NK-6288 | P3B |

TABLE 4

| | | | before | | |
|---|---|---|---|---|---|
| | Machbeth density | | discoloring | | preventing |
| | image | background | background | scanner | ability for |
| | part | color part | color part | readout | forgery |
| Example 1 | 1.48 | 0.08 | 0.18 | ◯ | ◯ |
| Example 2 | 1.45 | 0.09 | 0.18 | ◯ | ◯ |
| Example 3 | 1.44 | 0.08 | 0.17 | ◯ | ◯ |
| Example 4 | 1.49 | 0.15 | 0.21 | ◯ | ◯ |
| Example 5 | 1.45 | 0.07 | 0.20 | ◯ | ◯ |
| Example 6 | 1.42 | 0.08 | 0.19 | ◯ | ◯ |
| Example 7 | 1.46 | 0.08 | 0.19 | ◯ | ◯ |
| Example 8 | 1.48 | 0.16 | 0.22 | ◯ | ◯ |
| Example 9 | 1.53 | 0.07 | 0.17 | ◯ | ◯ |
| Example 10 | 1.51 | 0.07 | 0.16 | ◯ | ◯ |
| Example 11 | 1.50 | 0.08 | 0.17 | ◯ | ◯ |
| Example 12 | 1.55 | 0.13 | 0.19 | ◯ | ◯ |
| Example 13 | 1.50 | 0.09 | 0.18 | ◯ | ◯ |
| Example 14 | 1.49 | 0.08 | 0.18 | ◯ | ◯ |
| Example 15 | 1.52 | 0.08 | 0.19 | ◯ | ◯ |
| Example 16 | 1.48 | 0.14 | 0.21 | ◯ | ◯ |
| Example 17 | 1.45 | 0.08 | 0.16 | ◯ | ◯ |
| Example 18 | 1.48 | 0.13 | 0.18 | ◯ | ◯ |
| Comparative | 0.72 | 0.18 | 0.22 | X | Δ |
| Example 1 | | | | | |
| Comparative | 1.41 | 0.26 | 0.26 | X | X |
| Example 2 | | | | | |

Examples 19-36 and Comparative Examples 3-5 are indicating laser recording thermally sensitive recording media in a thermally sensitive layer of which, a photo absorbing material and an anti fading agent are contained together with.

As evaluation test, to the laser recording thermally sensitive recording media obtained in Examples 19-36 and Comparative Example 3-5, recording by laser is carried out using dry plotter-GX-3700 (wavelength 830 nm), which is a product of Matsushita Electric Works Graphic Printing Ltd., and the color density of the printed part and the background color part are measured by Macbeth densitometer RD-19.

After that, whole surface is irradiated by a visible light lamp of 600 nm wavelength, so as to deactivate the photo absorbing material and to make achromatic (discolor) and the color density of background color part is measured by Macbeth densitometer RD-19.

Further, readability when readout by a scanner (readout wavelength is 630 nm) is indicated as,

◯: can be readout well

x: accuracy for readout is bad (or can not be readout)

Further, after the laser recording thermally sensitive recording medium is discolored, laser recording process is carried out again, and a preventing ability for forgery (“addition of a postscript is impossible” is good) is indicated as,

◯: not develop color, addition of a postscript is impossible

Δ: slightly develops color

x: develops color and a postscript is possible

Then, for the evaluation of light resistance stability during preservation of the medium in the state to be exposed in natural light (room light such as fluorescent lamp or sun light), the laser recording thermally sensitive recording media obtained in Examples 19-36 and Comparative Example 3-5 are left for 24 hours exposing to a fluorescent lamp of 5000 Lx, then recording by laser is carried out on each specimen using a dry plotter-GX-3700 (wavelength 830 nm), which is a product of Matsushita Electric Works Graphic Printing Ltd., and the color density of the printed part and the background color part are measured by Macbeth densitometer RD-19. Light resistance stability by exposing to natural light is indicated as,
⊚: fading of background color part is not observed and has good color developing ability
◯: although background color part is slightly faded, has good color develop ability
Δ: slightly develops color
x: does not develop color and actual use is impossible

### Example 19

A Solution (Dispersion of Color Developing Agent)

| | |
|---|---|
| 4-hydroxy-4′-isopropoxydephenylsulfone <D-8> | 6.0 parts |
| 10% aqueous solution of polyvinylalcohol | 20.0 parts |
| water | 10.0 parts |

Mixture of above mentioned components is ground to average particle size of 1 μm using a sand grinder.

B solution (Dispersion of Photo Absorbing Material)

Photo absorbing agent represented by following structural formula (1)

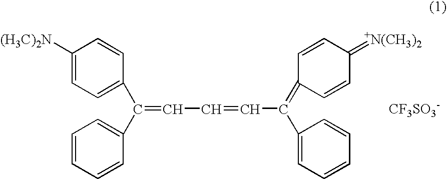

| | |
|---|---|
| <product of Showa Denko Co., Ltd., IR2MF> | 0.3 parts |
| 1,2-bis(phenoxymethyl)benzene <PMB-2> | 5.0 parts |
| 10% aqueous solution of polyvinylalcohol | 10.0 parts |
| water | 6.0 parts |

Mixture of above mentioned components is ground to average particle size of 1 μm using a sand grinder.

C Solution (Dispersion of Discoloring Agent)

Discoloring agent represented by following structural formula (2)

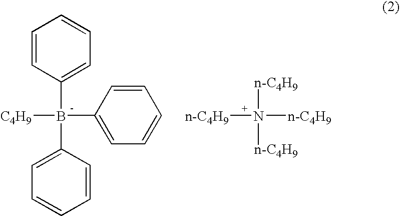

| | |
|---|---|
| <product of Showa Denko Co., P3B> | 0.3 parts |
| 1,2-bis(phenoxymethyl)benzene <PMB-2> | 5.0 parts |
| 10% aqueous solution of polyvinylalcohol | 10.0 parts |
| water | 6.0 parts |

Mixture of above mentioned components is ground to average particle size of 1 μm using a sand grinder.

D solution (Dispersion of Dye)

| | |
|---|---|
| 3-dibutylamino-6-methyl-7-anilino fluorane <OBD-2> | 3.0 parts |
| 10% aqueous solution of polyvinylalcohol | 5.0 parts |
| water | 2.0 parts |

Mixture of above mentioned components is ground to average particle size of 1 μm using a sand grinder.

F Solution (Dispersion of Heat Resistance Antioxidant)

| | |
|---|---|
| 2,2-bis(4-hydxoxyphenyl)propane | 6.0 parts |
| 10% aqueous solution of polyvinylalcohol | 20.0 parts |
| water | 10.0 parts |

Mixture of above mentioned components is ground to average particle size of 1 μm using a sand grinder.

Then above mentioned dispersions are mixed by the following ratio and a coating is obtained.

| | |
|---|---|
| A solution | 40.0 parts |
| B solution | 5.0 parts |
| C solution | 10.0 parts |
| D solution | 10.0 parts |
| F solution | 6.0 parts |
| 30% silica dispersion | 30.0 parts |

The obtained coating is coated on one surface of 60 g/m² paper so as the coating amount to be 7.0 g/m² and dried, and the laser recording thermally sensitive recording medium is prepared (in a thermally sensitive recording layer, using amount of photo absorbing material is 0.02 parts to 1 part of leuco dye).

### Example 20

By the same process as Example 19 except changing the discoloring agent of Example 19 to following discoloring agent represented by following structural formula,

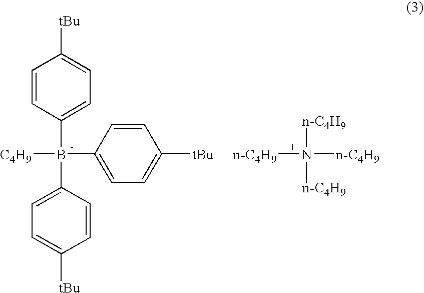

<product of Showa Denko Co., Ltd., BP3B>

and changing heat resistance antioxidant to 3,4-dihydroxyphenyl-p-tolyl sulfone, a laser recording thermally sensitive recording medium is obtained.

### Example 21

By the same process as Example 19 except changing the discoloring agent of Example 19 to following discoloring agent represented by following structural formula,

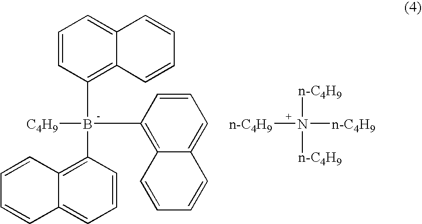

<product of Showa Denko Co., Ltd., N3B>

and changing F solution (dispersion of heat resistance antioxidant) to 20% dispersion of MgO, a laser recording thermally sensitive recording medium is obtained.

### Example 22

By the same process as Example 19 except not using C solution (discoloring agent) and changing F solution (dispersion of heat resistance antioxidant) to 20% dispersion of zinc stearate, a laser recording thermally sensitive recording medium is obtained.

### Example 23

By the same process as Example 19 except changing the photo absorbing material of Example 19 to following photo absorbing material represented by following structural formula,

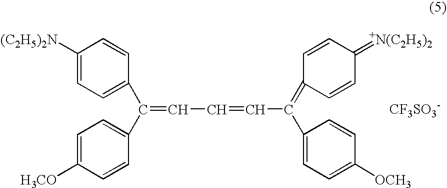

<product of Showa Denko Co., Ltd., IR13F>

and changing F solution (dispersion of heat resistance antioxidant) to 20% dispersion of zinc stearate, a laser recording thermally sensitive recording medium is obtained.

### Example 24

By the same process as Example 20 except changing the photo absorbing material of Example 20 to IR13F and changing a heat resistance antioxidant to 2,2-bis(4-hydroxyphenyl)propane, a laser recording thermally sensitive recording medium is obtained.

### Example 25

By the same process as Example 21 except changing the photo absorbing material of Example 21 to IR13F and changing a heat resistance antioxidant to 3,4-dihydroxyphenyl-p-tolyl sulfone, a laser recording thermally sensitive recording medium is obtained.

### Example 26

By the same process as Example 22 except changing the photo absorbing material of Example 22 to IR13F and changing F solution (dispersion of heat resistance antioxidant) to 20% dispersion of MgO, a laser recording thermally sensitive recording medium is obtained.

### Example 27

By the same process as Example 19 except changing the photo absorbing material of Example 19 to following photo absorbing material represented by following structural formula,

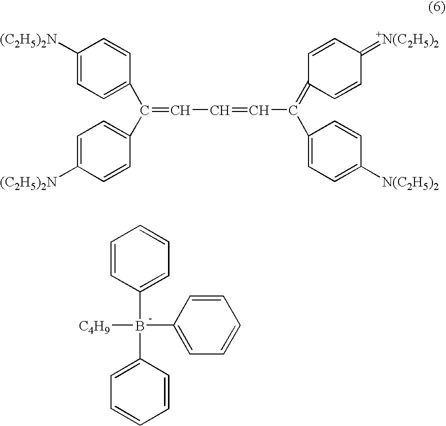

<product of Showa Denko Co., Ltd. IRB>

and changing F solution (dispersion of heat resistance antioxidant) to 20% dispersion of MgO, a laser recording thermally sensitive recording medium is obtained.

### Example 28

By the same process as Example 20 except changing the photo absorbing material of Example 20 to IRB and changing F solution (dispersion of heat resistance antioxidant) to 20% dispersion of zinc stearate, a laser recording thermally sensitive recording medium is obtained.

### Example 29

By the same process as Example 20 except changing the photo absorbing material of Example 20 to IRB and changing a heat resistance antioxidant to 2,2-bis(4-hydroxyphenyl)propane, a laser recording thermally sensitive recording medium is obtained.

### Example 30

By the same process as Example 22 except changing the photo absorbing material of Example 22 to IRB and changing a heat resistance antioxidant to 3,4-dihydroxyphenyl-p-tolyl sulfone, a laser recording thermally sensitive recording medium is obtained.

### Example 31

By the same process as Example 19 except changing the photo absorbing material of Example 19 to following photo absorbing material represented by following structural formula,

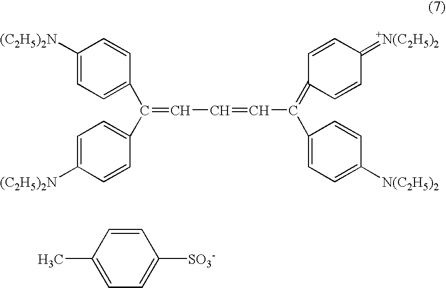

<product of Showa Denko Co., Ltd. IRT>

and changing a heat resistance antioxidant to 3,4-dihydroxyphenyl-p-tolyl sulfone, a laser recording thermally sensitive recording medium is obtained.

### Example 32

By the same process as Example 20 except changing the photo absorbing material of Example 20 to IRT, and changing F solution (dispersion of heat resistance antioxidant) to 20% dispersion of MgO, a laser recording thermally sensitive recording medium is obtained.

### Example 33

By the same process as Example 21 except changing the photo absorbing material of Example 20 to IRT, and changing F solution (dispersion of heat resistance antioxidant) to 20% dispersion of zinc stearate, a laser recording thermally sensitive recording medium is obtained.

### Example 34

By the same process as Example 22 except changing the photo absorbing material of Example 20 to IRT, and changing a heat resistance antioxidant to 2,2-bis(4-hydroxyphenyl)propane, a laser recording thermally sensitive recording medium is obtained.

### Example 35

Besides A, B, C, D and F solutions of Example 19, G solution is prepared. G solution (Dispersion of leuco dye which absorbs light of 600-700 nm wavelength)

| | |
|---|---|
| 3,3-bis(4-diethylamino-2-ethoxyphenol)-4-azaphthalide | 1.0 part |
| <GN-2> | |
| 10% aqueous solution of polyvinylalcohol | 5.0 parts |
| water | 2.0 parts |

Mixture of above mentioned components is ground to average particle size of 1 μm using a sand grinder.

Then above mentioned dispersions are mixed by the following ratio and a coating is obtained.

| | |
|---|---|
| A solution | 40.0 parts |
| B solution | 5.0 parts |
| C solution | 10.0 parts |
| D solution | 10.0 parts |
| F solution | 6.0 parts |
| G solution | 10.0 parts |
| 30% silica dispersion | 30.0 parts |

The obtained coating is coated on one surface of 60 g/m² paper so as the coating amount to be 7.0 g/m² and dried, and the laser recording thermally sensitive recording medium is prepared.

### Example 36

On the laser recording thermally sensitive recording medium obtained in Example 19 laser recording is carried out and by the same method as Example 19 except using an ultra violet ray lamp of wavelength 360 nm at discoloration process, evaluation test is carried out.

### Comparative Example 3

By the same process as Example 19 except changing the photo absorbing material of Example 19 to CY-20 (cyanine photo absorbing material), a laser recording thermally sensitive recording medium is obtained.

### Comparative Example 4

By the same process as Example 19 except changing the photo absorbing material of Example 19 to NK-6288 (cyanine photo absorbing material), a laser recording thermally sensitive recording medium is obtained.

### Comparative Example 5

By the same process as Example 19 except not using F solution (dispersion of heat resistance antioxidant), a laser recording thermally sensitive recording medium is obtained.

Photo absorbing materials, discoloring agents and an anti fading agent used in above Examples and Comparative Examples are summarized in Table 5 and results are summarized in Table 6.

TABLE 5

| | Photo | Dis- | |
|---|---|---|---|
| | absorbing | coloring | |
| | material | agent | Anti fading agent |
| Example 19 | IR2MF | P3B | 2,2-bis(4-hydroxyphenyl)propane |
| Example 20 | IR2MF | BP3B | 3,4-dihydroxyphenyl-p-tolylsulfone |
| Example 21 | IR2MF | N3B | MgO |
| Example 22 | IR2MF | — | zinc stearate |
| Example 23 | IR13F | P3B | zinc stearate |
| Example 24 | IR13F | BP3B | 2,2-bis(4-hydroxyphenyl)propane |
| Example 25 | IR13F | N3B | 3,4-dihydroxyphenyl-p-tolylsulfone |
| Example 26 | IR13F | — | MgO |
| Example 27 | IRB | P3B | MgO |
| Example 28 | IRB | BP3B | zinc stearate |
| Example 29 | IRB | N3B | 2,2-bis(4-hydroxyphenyl)propane |
| Example 30 | IRB | — | 3,4-dihydroxyphenyl-p-tolylsulfone |
| Example 31 | IRT | P3B | 3,4-dihydroxyphenyl-p-tolylsulfone |
| Example 32 | IRT | BP3B | 3,4-dihydroxyphenyl-p-tolylsulfone |
| Example 33 | IRT | N3B | MgO |
| Example 34 | IRT | — | zinc stearate |
| Example 35 | IR2MF | P3B | 2,2-bis(4-hydroxyphenyl)propane |
| Example 36 | IR2MF | P3B | 2,2-bis(4-hydroxyphenyl)propane |
| Comparative | CY-20 | P3B | 2,2-bis(4-hydroxyphenyl)propane |
| Example 3 | | | |
| Comparative | NK-6288 | P3B | 2,2-bis(4-hydroxyphenyl)propane |
| Example 4 | | | |
| Comparative | IR2ME | P3B | — |
| Example 5 | | | |

TABLE 6

| | Machbeth | | before | | | |
|---|---|---|---|---|---|---|
| | density | | discoloring | | | |
| | | background | background | | preventing | |
| | image | color | color | scanner | ability for | light resistance |
| | part | part | part | readout | forgery | stability |
| Exp. 19 | 1.47 | 0.08 | 0.17 | ◯ | ◯ | ◯ |
| Exp. 20 | 1.44 | 0.88 | 0.19 | ◯ | ◯ | ◯ |
| Exp. 21 | 1.45 | 0.09 | 0.16 | ◯ | ◯ | ◯ |
| Exp. 22 | 1.50 | 0.14 | 0.20 | ◯ | ◯ | ◯ |
| Exp. 23 | 1.44 | 0.08 | 0.21 | ◯ | ◯ | ◯ |
| Exp. 24 | 1.45 | 0.08 | 0.18 | ◯ | ◯ | ◯ |
| Exp. 25 | 1.44 | 0.08 | 0.17 | ◯ | ◯ | ◯ |
| Exp. 26 | 1.45 | 0.17 | 0.22 | ◯ | ◯ | ◯ |
| Exp. 27 | 1.53 | 0.07 | 0.16 | ◯ | ◯ | ◯ |
| Exp. 28 | 1.50 | 0.08 | 0.17 | ◯ | ◯ | ◯ |
| Exp. 29 | 1.53 | 0.08 | 0.17 | ◯ | ◯ | ◯ |
| Exp. 30 | 1.52 | 0.12 | 0.20 | ◯ | ◯ | ◯ |
| Exp. 31 | 1.49 | 0.09 | 0.18 | ◯ | ◯ | ◯ |
| Exp. 32 | 1.46 | 0.08 | 0.17 | ◯ | ◯ | ◯ |
| Exp. 33 | 1.53 | 0.08 | 0.20 | ◯ | ◯ | ◯ |
| Exp. 34 | 1.48 | 0.14 | 0.21 | ◯ | ◯ | ◯ |
| Exp. 35 | 1.47 | 0.08 | 0.15 | ◯ | ◯ | ◯ |
| Exp. 36 | 1.48 | 0.14 | 0.18 | ◯ | ◯ | ◯ |
| Co. Exp. 3 | 0.70 | 0.19 | 0.23 | X | Δ | Δ |
| Co. Exp. 4 | 1.43 | 0.28 | 0.28 | X | X | ◯ |
| Co. Exp. 5 | 1.45 | 0.08 | 0.19 | ◯ | ◯ | X |

Examples 37-54 and Comparative Examples 6-8 are indicating cases of laser recording thermally sensitive recording media in a thermally sensitive layer of which, a photo absorbing material and an ultra violet ray absorbing agent, or an ultra violet ray absorbing agent and a hindered amine photo stabilizing agent are contained together with.

Evaluation tests are same as Examples 19-35 and Comparative Examples 3-5.

### Example 37

A solution (dispersion of color developing agent), B solution (dispersion of photo absorbing agent IR2MF), C solution (dispersion of discoloring agent P3B) and D solution (dispersion of dye) are prepared by same process of Example 19, and as a dispersion of ultra violet ray absorbing agent, following H solution is prepared.

H Solution (Dispersion of Ultra Violet Ray Absorbing Agent)

| | |
|---|---|
| 2,2-methylenebis[4-(1,1,3,3-tetramethylbutyl)-6-(2H- | 3.0 part |
| benzotriazol-2-yl)phenol]<Adekastab LA-31> | |
| 10% aqueous solution of polyvinylalcohol | 6.0 parts |
| water | 6.0 parts |

Mixture of above mentioned components is ground to average particle size of 1 μm using a sand grinder.

I solution (Dispersion of Hindered Amines Photo Stabilizing Agent)

hindered amine photo stabilizing agent represented by following structural formula (8)

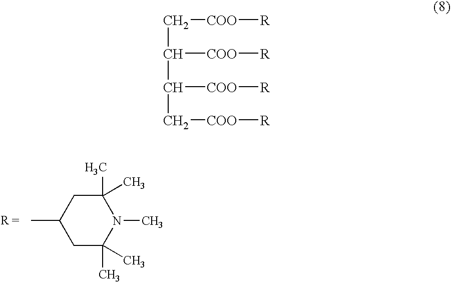

| | |
|---|---|
| <Adekastab LA-31> | 3.0 parts |
| 10% aqueous solution of polyvinylalcohol | 6.0 parts |
| water | 6.0 parts |

Mixture of above mentioned components is ground to average particle size of 1 μm using a sand grinder. Then above mentioned dispersions are mixed by the following ratio and a coating is obtained.

| | |
|---|---|
| A solution | 40.0 parts |
| B solution | 5.0 parts |
| C solution | 10.0 parts |
| D solution | 10.0 parts |
| H solution | 10.0 parts |
| I solution | 10.0 parts |
| 30% silica dispersion | 30.0 parts |

The obtained coating is coated on one surface of 60 g/m² paper so as the coating amount to be 7.0 g/m² and dried, and the laser recording thermally sensitive recording medium is prepared (in thermally sensitive recording layer, amount of photo absorbing agent is 0.02 parts to 1 part of leuco dye).

### Example 38

By the same process as Example 37 except changing the discoloring agent used in Example 37 (BP3B; product of Showa Denko) to 2-(2′-hydroxy-3′-t-butyl-5′-methylphenyl)-5-chlorobenzotriazol <Tomisoap 600> which is ultra violet absorbing agent and not using hindered amines photo stabilizing agent, a laser recording thermally sensitive recording medium is prepared.

### Example 39

By the same process as Example 37 except changing the discoloring agent used in Example 37 (BP3B; product of Showa Denko) to aqueous emulsion of polymer ultra violet ray absorbing agent (30% shortened to UVA1) disclosed in JP2001-150810 publication, a laser recording thermally sensitive recording medium is prepared.

### Example 40

By the same process as Example 38 except not using C solution (discoloring agent) of Example 38 and changing ultra violet ray absorbing agent to 2,2′-p-phenylenebis(4H-3,1-benzooxadine-4-on) (shortened to UVA2), a laser recording thermally sensitive recording medium is prepared.

### Example 41

By the same process as Example 37 except changing the photo absorbing agent to the photo absorbing material (IR13F; product of Showa Denko) used in Example 37, changing ultra violet ray absorbing agent to 2,2′-p-phenylenebis(4H-3,1-benzooxadine-4-on) and not using hindered amines photo stabilizing agent, a laser recording thermally sensitive recording medium is prepared.

### Example 42

By the same process as Example 38 except changing the photo absorbing agent to IR13F, which is a product of Showa Denko, changing ultra violet ray absorbing agent to 2,2-methylenebis[4-(1,1,3,3-tetrabutyl)-6-(2H-benzotriazole-2-yl)phenol] <Adekastab LA-31>, and changing hindered amines photo stabilizing agent of I solution to 10 parts of hindered amine photo stabilizing agent represented by structural formula (9),

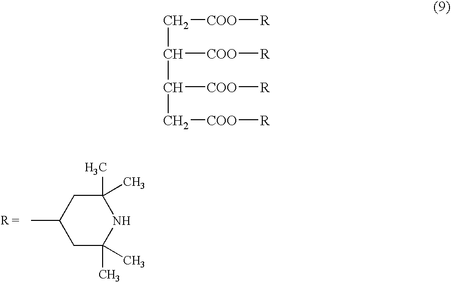

### <Adekastab LA-57>

a laser recording thermally sensitive recording medium is prepared.

### Example 43

By the same process as Example 39 except changing the photo absorbing agent of Example 39 to IR13F, which is a product of Showa Denko, and changing ultra violet ray absorbing agent to 2-(2′-hydroxy-3′-t-butyl-5′-methylphenyl)-5-chlorobenzotriazol <Tomisoap 600>, a laser recording thermally sensitive recording medium is prepared.

### Example 44

By the same process as Example 40 except changing the photo absorbing agent of Example 40 to IR13F, which is a product of Showa Denko, and changing ultra violet ray absorbing agent to aqueous emulsion of polymer ultra violet ray absorbing agent (30%) disclosed in JP2001-150810 publication, a laser recording thermally sensitive recording medium is prepared.

### Example 45

By the same process as Example 37 except changing the photo absorbing agent of Example 37 to the photo absorbing agent used in Example 37 (IRB; a product of Showa Denko), changing ultra violet ray absorbing agent to aqueous emulsion of polymer ultra violet ray absorbing agent (30%) disclosed in JP2001-150810 publication and not using hindered amines photo stabilizing agent, a laser recording thermally sensitive recording medium is prepared.

### Example 46

By the same process as Example 38 except changing the photo absorbing agent of Example 38 to IRB, which is a product of Showa Denko, and changing ultra violet ray absorbing agent to 2,2′-p-phenylenebis(4H-3,1-benzooxadine-4-on), a laser recording thermally sensitive recording medium is prepared.

### Example 47

By the same process as Example 39 except changing the photo absorbing agent to IRB, which is a product of Showa Denko, changing ultra violet ray absorbing agent to 2,2-methylenebis[4-(1,1,3,3-tetrabutyl)-6-(2H-benzotriazole-2-yl)phenol] <Adekastab LA-31>, and changing hindered amines photo stabilizing agent of I solution to 10 parts of hindered amine photo stabilizing agent represented by structural formula (10),

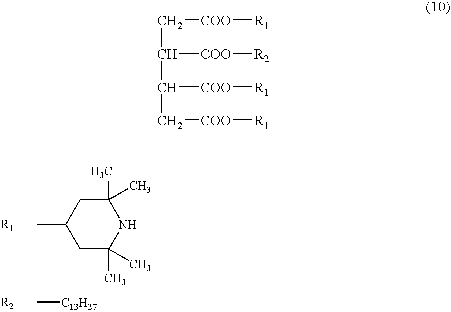

### <Adekastab LA-67>

a laser recording thermally sensitive recording medium is prepared.

### Example 48

By the same process as Example 40 except changing the photo absorbing agent of Example 40 to IRB, which is a product of Showa Denko, and changing ultra violet ray absorbing agent to 2-(2′-hydroxy-3′-t-butyl-5′-methylphenyl)-5-chlorobenzotriazol <Tomisoap 600>, a laser recording thermally sensitive recording medium is prepared.

### Example 49

By the same process as Example 37 except changing the photo absorbing agent of Example 40 to the photo absorbing agent used in Example 13 (IRT; a product of Showa Denko), which is a product of Showa Denko, changing ultra violet ray absorbing agent to 2-(2′-hydroxy-3′-t-butyl-5′-methylphenyl)-5-chlorobenzotriazol <Tomisoap 600> and not using hindered amines photo stabilizing agent, a laser recording thermally sensitive recording medium is prepared.

### Example 50

By the same process as Example 38 except changing the photo absorbing agent of Example 38 to IRT, which is a product of Showa Denko, and changing ultra violet ray absorbing agent to aqueous emulsion of polymer ultra violet ray absorbing agent (30%) disclosed in JP2001-150810 publication, a laser recording thermally sensitive recording medium is prepared.

### Example 51

By the same process as Example 39 except changing the photo absorbing agent of Example 39 to IRT, which is a product of Showa Denko, and changing ultra violet ray absorbing agent to dispersion of 2,2′-p-phenylene bis(4H-3,1-benzooxadine-4-on) (UVA2), a laser recording thermally sensitive recording medium is prepared.

### Example 52

By the same process as Example 40 except changing the photo absorbing agent of Example 40 to IRT, which is a product of Showa Denko, and changing ultra violet ray absorbing agent to 2,2-methylenebis[4-(1,1,3,3-tetramethylbutyl)-6-(2H-benzotriazol-2-yl)phenol] <Adekastab LA-31> and adding 10 parts of hindered amine photo stabilizing agent of I solution, a laser recording thermally sensitive recording medium is prepared.

### Example 53

Besides A, B, C, D, H and I solutions, J solution is prepared.

J Solution (Dispersion of Leuco Dye which Absorbs Light of 600-700 nm Wavelength)

| | |
|---|---|
| 3,3-bis(4-diethylamino-2-ethoxyphenyl-4-azaphthalide | 1.0 part |
| <GN-2> | |
| 10% aqueous solution of polyvinylalcohol | 5.0 parts |
| water | 2.0 parts |

Mixture of above mentioned components is ground to average particle size of 1 μm using a sand grinder.

Then above mentioned dispersions are mixed by the following ratio and a coating is obtained.

| | |
|---|---|
| A solution | 40.0 parts |
| B solution | 5.0 parts |
| C solution | 10.0 parts |
| D solution | 10.0 parts |
| H solution | 10.0 parts |
| I solution | 10.0 parts |
| J solution | 10.0 parts |
| 30% silica dispersion | 30.0 parts |

The obtained coating is coated on one surface of 60 g/m² paper so as the coating amount to be 7.0 g/m² and dried, and a laser recording thermally sensitive recording medium is prepared.

### Example 54

On the laser recording thermally sensitive recording medium obtained in Example 37 laser recording is carried out and by the same method as Example 37 except using an ultra violet ray lamp of wavelength 360 nm at discoloration process, evaluation test is carried out.

### Comparative Example 6

By the same process as Example 37 except changing photo absorbing material of Example 37 to CY-20 (cyanine photo absorbing material), which is a product of Nihon Kayaku Co., Ltd., a laser recording thermally sensitive recording medium is prepared.

### Comparative Example 7

By the same process as Example 37 except changing the photo absorbing material of Example 37 to NK-6288 (product of Hayashi Protist Chemical Laboratory, cyanine photo absorbing material), a laser recording thermally sensitive recording medium is obtained.

### Comparative Example 7

By the same process as Example 37 except not using H solution (ultra violet ray absorbing agent) and I solution (hindered amine photo stabilizing agent), a laser recording thermally sensitive recording medium is obtained.

Photo absorbing materials, discoloring agents, ultra violet ray absorbing agent and an hindered amine photo stabilizing agent used in above Examples and Comparative Examples are summarized in Table 7 and results are summarized in Table 8.

TABLE 7

| | | | | hindered |
|---|---|---|---|---|
| | photo | | ultraviolet ray | amine photo |
| | absorbing | discoloring | absorbing | stabilizing |
| | material | agent | agent | agent |
| Example 37 | IR2MF | P3B | Adekastab LA-31 | Adekastab |
| | | | | LA-52 |
| Example 38 | IR2MF | BP3B | Tomi soap 600 | — |
| Example 39 | IR2MF | N3B | UVA1 | — |
| Example 40 | IR2MF | — | UVA2 | — |
| Example 41 | IR13F | P3B | UVA2 | — |
| Example 42 | IR13F | BP3B | Adekastab LA-31 | Adekastab |
| | | | | LA-57 |
| Example 43 | IR13F | N3B | Tomi soap 600 | — |
| Example 44 | IR13F | — | UVA1 | — |
| Example 45 | IRB | P3B | UVA1 | — |
| Example 46 | IRB | BP3B | UVA2 | — |
| Example 47 | IRB | N3B | Adekastab LA-31 | Adekastab |
| | | | | LA-67 |
| Example 48 | IRB | — | Tomi soap 600 | — |
| Example 49 | IRT | P3B | Tomi soap 600 | — |
| Example 50 | IRT | BP3B | UVA1 | — |
| Example 51 | IRT | N3B | UVA2 | — |
| Example 52 | IRT | — | Adekastab LA-31 | Adekastab |
| | | | | LA-52 |
| Example 53 | IR2MF | P3B | Adekastab LA-31 | Adekastab |
| | | | | LA-52 |
| Example 54 | IR2MF | P3B | Adekastab LA-31 | Adekastab |
| | | | | LA-52 |
| Co. | CY-20 | P3B | Adekastab LA-31 | Adekastab |
| Example 6 | | | | LA-52 |
| Co. | NK-6288 | P3B | Adekastab LA-31 | Adekastab |
| Example 7 | | | | LA-52 |
| Co. | IR2ME | P3B | — | — |
| Example 8 | | | | |

UVA1: aqueous emulsion polymer ultra violet ray absorbing agents disclosed in JP 2001-150810
UVA2: 2,2′-p-phenylenebis(4H-3,1-benzooxadine-4-on)

TABLE 8

| | | | (before | | | |
|---|---|---|---|---|---|---|
| | Machbeth density | | discoloring) | | preventing | light |
| | | ground | ground | scanner | ability | resistance |
| | image part | color part | color part | readout | for forgery | stability |
| Example 37 | 1.48 | 0.08 | 0.17 | ◯ | ◯ | ⊚ |
| Example 38 | 1.45 | 0.08 | 0.18 | ◯ | ◯ | ◯ |
| Example 39 | 1.47 | 0.08 | 0.16 | ◯ | ◯ | ◯ |
| Example 40 | 1.50 | 0.15 | 0.19 | ◯ | ◯ | ◯ |
| Example 41 | 1.46 | 0.08 | 0.20 | ◯ | ◯ | ◯ |
| Example 42 | 1.45 | 0.09 | 0.18 | ◯ | ◯ | ⊚ |
| Example 43 | 1.46 | 0.08 | 0.18 | ◯ | ◯ | ◯ |
| Example 44 | 1.46 | 0.16 | 0.21 | ◯ | ◯ | ◯ |
| Example 45 | 1.51 | 0.07 | 0.17 | ◯ | ◯ | ◯ |
| Example 46 | 1.52 | 0.08 | 0.18 | ◯ | ◯ | ◯ |
| Example 47 | 1.53 | 0.08 | 0.16 | ◯ | ◯ | ⊚ |
| Example 48 | 1.50 | 0.13 | 0.19 | ◯ | ◯ | ◯ |
| Example 49 | 1.47 | 0.08 | 0.19 | ◯ | ◯ | ◯ |
| Example 50 | 1.46 | 0.09 | 0.17 | ◯ | ◯ | ◯ |
| Example 51 | 1.51 | 0.08 | 0.21 | ◯ | ◯ | ◯ |
| Example 52 | 1.48 | 0.15 | 0.21 | ◯ | ◯ | ⊚ |
| Example 53 | 1.47 | 0.09 | 0.16 | ◯ | ◯ | ⊚ |
| Example 54 | 1.48 | 0.16 | 0.19 | ◯ | ◯ | ⊚ |
| Co. Example 6 | 0.72 | 0.20 | 0.24 | X | Δ | Δ |
| Co. Example 7 | 1.45 | 0.27 | 0.28 | X | X | ◯ |
| Co. Example 8 | 1.45 | 0.08 | 0.19 | ◯ | ◯ | X |

1. (canceled)

2. A laser recording thermally sensitive recording medium comprising, a thermally sensitive recording layer containing at least a photo absorbing material which absorbs laser ray and covert the laser ray to heat, an electron donating leuco dye and an electron accepting color developing agent on a substrate as main components, wherein said photo absorbing material is a compound represented by general formula (1), 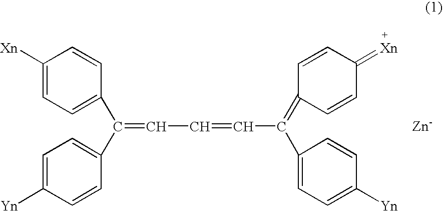
wherein, n indicates ab integer from 1 to 4, and structural formula ox Xn, Yn, and Zn⁻are indicated in Table 1.
TABLE 1

| | n = 1 | n = 2 | n = 3 | n = 4 |
|---|---|---|---|---|
| Xn | N(C₂H₅)₂ | N(C₂H₅)₂ | N(CH₃)₂ | N(C₂H₅)₂ |
| Yn | N(C₂H₅)₂ | N(C₂H₅)₂ | H | OCH₃ |
| Zn⁻ | 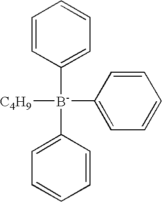 | 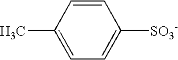 | CF₃SO₃⁻ | CF₃SO₃⁻ |

said laser recording thermally sensitive recording medium further comprising, compound represented by general formula (2) as a discoloring agent, 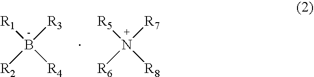
wherein, R₁, R₂, R₃ and R₄ are respectively independently indicating alkyl group, aryl group, allyl group, aralkyl group, alkenyl group, alkinyl group, sillyl group, heterocyclic group, substituted alkyl group, substituted aryl group, substituted allyl group, substituted aralkyl group, substituted alkenyl group, substituted alkinyl group or substituted sillyl group, at least one of R₁, R₂, R₃ or R₄ is an alkyl group of carbon number 1-12, R₅, R₆, R₇ and R₈ are respectively independently indicating hydrogen atom, alkyl group, aryl group, allyl group, aralkyl group, alkenyl group, alkinyl group, heterocyclic group, substituted alkyl group, substituted aryl group, substituted allyl group, substituted aralkyl group, substituted alkenyl group, or substituted alkinyl group.

3. The laser recording thermally sensitive recording medium of claim 2, wherein the discoloring agent is a compound represented by general formula (3), 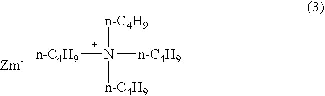
wherein, m indicates a anteger of 1-3, and structural formulae of Zm⁻are shown in Table 2.

| | m = 1 | m = 2 | m = 3 |
|---|---|---|---|
| Zm⁻ | 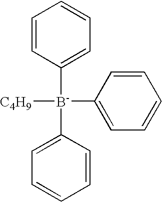 | 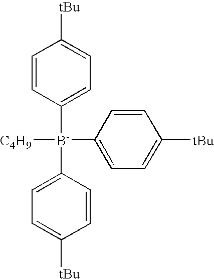 | 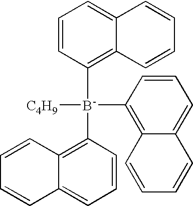 |

4. The laser recording thermally sensitive recording medium according to claim 1, further containing any one of \textcircled{1} to \textcircled{3},
\textcircled{1} anti fading agent,
\textcircled{2} ultra violet ray absorbing agent,
\textcircled{3} ultra violet ray absorbing agent and hindered amine photo stabilizing agent, which is an antioxidant.

5. The laser recording thermally sensitive recording medium of claim 4, wherein the anti fading agent is at least one compound selected from the group consisting of heat resistance antioxidant, metal oxide or metal soap.

6. The laser recording thermally sensitive recording medium of claim 4, wherein the ultra violet ray absorbing agent is benzotriazol ultra violet ray absorbing agent.

7. A method for use of the laser recording thermally sensitive recording medium according to claim 2 comprising, carrying out laser recording on the laser recording thermally sensitive recording medium, then irradiate light of level which does not cause color development of a thermally sensitive recording layer so as a photo absorbing material to be deactivated and making impossible the addition of postscript.
